(19) United States
(12) Patent Application Publication
(10) Pub. No.: US 2013/0311548 A1
(43) Pub. Date: Nov. 21, 2013

(54) VIRTUALIZED GRAPHICS PROCESSING FOR REMOTE DISPLAY

(71) Applicant: NVIDIA CORPORATION, Santa Clara, CA (US)

(72) Inventors: Jen-Hsun Huang, Los Altos Hills, CA (US); Franck R. Diard, Mountain View, CA (US); Andrew Currid, Alameda, CA (US)

(73) Assignee: NVIDIA CORPORATION, Santa Clara, CA (US)

(21) Appl. No.: 13/727,357

(22) Filed: Dec. 26, 2012

Related U.S. Application Data
(60) Provisional application No. 61/647,331, filed on May 15, 2012.
(60) Provisional application No. 61/730,940, filed on Nov. 28, 2012.

(51) Int. Cl. H04L 29/06

(52) U.S. Cl. CPC H04L 67/42
USPC 709/203

(57) ABSTRACT

User inputs are received from end user devices. The user inputs are associated with applications executing in parallel on a computer system. Responsive to the user inputs, data is generated using a graphics processing unit (GPU) configured as multiple virtual GPUs that are concurrently utilized by the applications. The data is then directed to the proper end user devices for display.

### RELATED U.S. APPLICATION

This application claims priority to the U.S. Provisional Application filed on May 15, 2012, entitled “Virtualized Graphics Processing for Remote Display,” Ser. No. 61/647,331, hereby incorporated by reference in its entirety. This application also claims priority to the U.S. Provisional Application filed on Nov. 28, 2012, entitled “Grid-Related Inventions,” Ser. No. 61/730,940, also hereby incorporated by reference in its entirety.

### BACKGROUND

Historically, an application such as a video game was executed (played) using a personal computer (PC) or using a console attached to a television. A user purchased or rented a game, which was loaded onto the PC or inserted into the game console and then played in a well known manner.

More recently, online gaming has become popular. An online game is played over a network such as the Internet. The game is loaded onto the user's device while other software needed to play the game resides on a server that is accessed via the network. Generally speaking, the game is executed on both the user's device and the server. Online gaming allows multiple users to compete against each other in the game environment provided by the software on the server.

Even more recently, cloud gaming has been gaining in popularity. Cloud gaming is a type of online gaming in which the actual game is stored on the server, in contrast to the type of online gaming mentioned above. The server executes the game in response to control information received from the user and streams the resulting content to the user's device. Cloud gaming reduces the importance of the capabilities of the user's device.

### SUMMARY

Embodiments according to the present invention pertain to systems and methods that facilitate and enhance online gaming, particularly cloud gaming (also known as gaming on demand). However, embodiments according to the present invention are not limited to gaming applications and can be extended to other types of applications.

In one embodiment, user inputs are received from end user devices or client devices. The user inputs are associated with applications executing in parallel on a computer system (e.g., a server). Responsive to the user inputs, data is generated using a physical graphics processing unit (GPU) configured as multiple virtual GPUs that are concurrently utilized by the applications. The computer system may host more than one such physical GPU. Each instance of an application may be associated with one of the virtual GPUs. The virtual GPUs execute the various applications, process the various inputs in parallel, and generate output data accordingly. The data is then respectively directed to the end user devices for display by those devices; each end user device receives the portion of the output data it is supposed to receive. The end user devices are remote to the computer system that hosts the virtual GPUs.

In one embodiment, user input is received at a centralized server device comprising a GPU configured for concurrent use by multiple applications executing in parallel (that is, a GPU configured as multiple virtual GPUs). The user input is received from an independent (e.g., remotely located) client device communicatively coupled to the server device. The user input is associated with one of the applications. Data is generated with the GPU according to the user input. The generated data includes graphics data suitable for display. The data is sent from the server device to the client device using one or more communication paths that may include the Internet and that may be wired or wireless. The client device is configured to decode the data for display on a display device. In one embodiment, the data is compressed image data that is streamed from the server device to the client device. In one embodiment, the application is a video game.

In parallel to (concurrently with) the above operations, other user input is received at the server device, from another (second) independent client device communicatively coupled to the server device. The second user input is associated with a second application (which may the same or different from the application referred to above). Also concurrent with the above operations, data is generated using the GPU according to the second user input and sent from the server device to the second client device.

In one embodiment, information indicating that the application is available to the client device is accessed. That is, a check is performed to determine whether or not a user is authorized to use the application.

There are a number of advantages associated with the features of the present invention. For example, hardware used to execute an application is instantiated on the server device and as a result the user can utilize the application with only a thin client—the client device may only need to be able to decode (decompress) and display the data received from the user, while also permitting the user to interact with the application on the server device (e.g., receive user inputs and transmit them to the server). Consequently, significant hardware updates such as advanced GPUs can be implemented at the server, and thus users do not have to purchase new devices as technologies evolve. Also, the server can compress the output (e.g., display) data using a commonly used format such as H.264 format. In other words, the client devices—as thin devices—may be very much alike in the sense that they are each able to decode data using a common, standardized, and readily available scheme. Therefore, it is not necessary to develop and maintain different versions of an application to suit different types of client platforms. Furthermore, digital rights management (DRM) is facilitated because the application resides on the server, making it easier to control distribution and use.

These and other objects and advantages of the various embodiments of the present disclosure will be recognized by those of ordinary skill in the art after reading the following detailed description of the embodiments that are illustrated in the various drawing figures.

### BRIEF DESCRIPTION OF THE DRAWINGS

The accompanying drawings, which are incorporated in and form a part of this specification and in which like numerals depict like elements, illustrate embodiments of the present disclosure and, together with the description, serve to explain the principles of the disclosure.

FIG. 1A is a block diagram of an example of a server computer system capable of implementing embodiments according to the present invention.

FIG. 1B is a block diagram of an example of a client device capable of implementing embodiments according to the present invention.

FIG. 2 illustrates an example of a graphics system in an embodiment according to the present invention.

FIG. 3 is a block diagram of a system capable of implementing embodiments according to the present invention.

FIG. 4 is a block diagram representing the flow of data from a virtual GPU to a client device in an embodiment according to the present invention.

FIG. 5 is a flowchart of an example of a computer-implemented method for providing virtualized graphics processing for remote display in an embodiment according to the present invention.

### DETAILED DESCRIPTION

Reference will now be made in detail to the various embodiments of the present disclosure, examples of which are illustrated in the accompanying drawings. While described in conjunction with these embodiments, it will be understood that they are not intended to limit the disclosure to these embodiments. On the contrary, the disclosure is intended to cover alternatives, modifications and equivalents, which may be included within the spirit and scope of the disclosure as defined by the appended claims. Furthermore, in the following detailed description of the present disclosure, numerous specific details are set forth in order to provide a thorough understanding of the present disclosure. However, it will be understood that the present disclosure may be practiced without these specific details. In other instances, well-known methods, procedures, components, and circuits have not been described in detail so as not to unnecessarily obscure aspects of the present disclosure.

Some portions of the detailed descriptions that follow are presented in terms of procedures, logic blocks, processing, and other symbolic representations of operations on data bits within a computer memory. These descriptions and representations are the means used by those skilled in the data processing arts to most effectively convey the substance of their work to others skilled in the art. In the present application, a procedure, logic block, process, or the like, is conceived to be a self-consistent sequence of steps or instructions leading to a desired result. The steps are those utilizing physical manipulations of physical quantities. Usually, although not necessarily, these quantities take the form of electrical or magnetic signals capable of being stored, transferred, combined, compared, and otherwise manipulated in a computer system. It has proven convenient at times, principally for reasons of common usage, to refer to these signals as transactions, bits, values, elements, symbols, characters, samples, pixels, or the like.

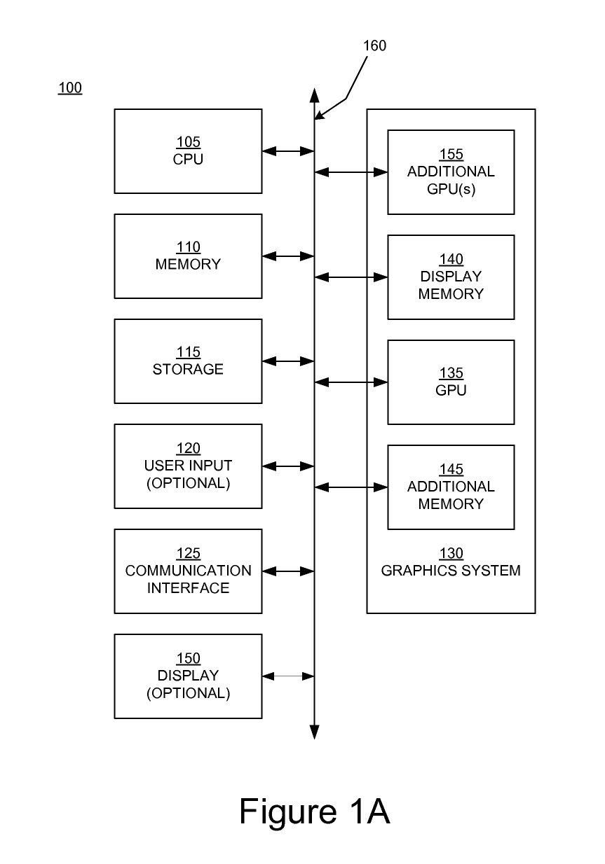

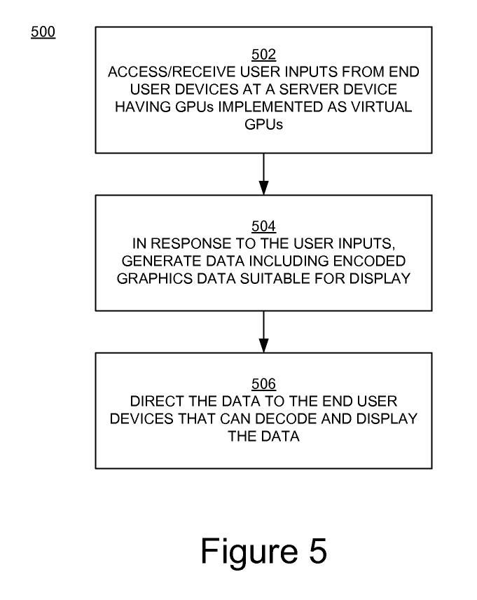

It should be borne in mind, however, that all of these and similar terms are to be associated with the appropriate physical quantities and are merely convenient labels applied to these quantities. Unless specifically stated otherwise as apparent from the following discussions, it is appreciated that throughout the present disclosure, discussions utilizing terms such as “receiving,” “generating,” “sending,” “decoding,” “encoding,” “accessing,” “streaming,” or the like, refer to actions and processes (e.g., flowchart 500 of FIG. 5) of a computer system or similar electronic computing device or processor (e.g., system 100 of FIG. 1A). The computer system or similar electronic computing device manipulates and transforms data represented as physical (electronic) quantities within the computer system memories, registers or other such information storage, transmission or display devices.

Embodiments described herein may be discussed in the general context of computer-executable instructions residing on some form of computer-readable storage medium, such as program modules, executed by one or more computers or other devices. By way of example, and not limitation, computer-readable storage media may comprise non-transitory computer-readable storage media and communication media; non-transitory computer-readable media include all computer-readable media except for a transitory, propagating signal. Generally, program modules include routines, programs, objects, components, data structures, etc., that perform particular tasks or implement particular abstract data types. The functionality of the program modules may be combined or distributed as desired in various embodiments.

Computer storage media includes volatile and nonvolatile, removable and non-removable media implemented in any method or technology for storage of information such as computer-readable instructions, data structures, program modules or other data. Computer storage media includes, but is not limited to, random access memory (RAM), read only memory (ROM), electrically erasable programmable ROM (EEPROM), flash memory or other memory technology, compact disk ROM (CD-ROM), digital versatile disks (DVDs) or other optical storage, magnetic cassettes, magnetic tape, magnetic disk storage or other magnetic storage devices, or any other medium that can be used to store the desired information and that can accessed to retrieve that information.

Communication media can embody computer-executable instructions, data structures, and program modules, and includes any information delivery media. By way of example, and not limitation, communication media includes wired media such as a wired network or direct-wired connection, and wireless media such as acoustic, radio frequency (RF), infrared, and other wireless media. Combinations of any of the above can also be included within the scope of computer-readable media.

FIG. 1A is a block diagram of an example of a computer system 100 capable of implementing embodiments according to the present invention. In the example of FIG. 1A, the computer system 100 includes a central processing unit (CPU) 105 for running software applications and optionally an operating system. Memory 110 stores applications and data for use by the CPU 105. Storage 115 provides non-volatile storage for applications and data and may include fixed disk drives, removable disk drives, flash memory devices, and CD-ROM, DVD-ROM or other optical storage devices. The optional user input 120 includes devices that communicate user inputs from one or more users to the computer system 100 and may include keyboards, mice, joysticks, touch screens, and/or microphones. The communication or network interface 125 allows the computer system 100 to communicate with other computer systems via an electronic communications network, including wired and/or wireless communication and including the Internet. The optional display device 150 is any device capable of displaying visual information in response to a signal from the computer system 100. The components of the computer system 100, including the CPU 105, memory 110, data storage 115, user input devices 120, communication interface 125, and the display device 150, are connected via one or more data buses 160.

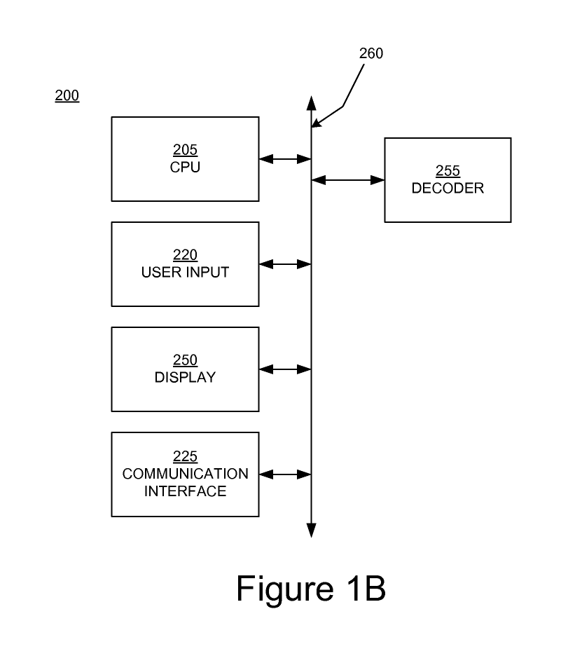

In the FIG. 1A embodiment, a graphics system 130 is connected with the data bus 160 and the components of the computer system 100. The graphics system 130 may include a physical graphics processing unit (GPU) 135 and graphics memory. The GPU 135 generates pixel data for output images from rendering commands. As discussed further in conjunction with FIG. 2, the physical GPU 135 can be configured as multiple virtual GPUs that are used in parallel (concurrently) by a number of applications executing in parallel.

Graphics memory may include a display memory 140 (e.g., a framebuffer) used for storing pixel data for each pixel of an output image. In another embodiment, the display memory 140 and/or additional memory 145 are part of the memory 110 and are shared with the CPU 105. Alternatively, the display memory 140 and/or additional memory 145 can be one or more separate memories provided for the exclusive use of the graphics system 130.

In another embodiment, graphics processing system 130 includes one or more additional physical GPUs 155, similar to the GPU 135. Each additional GPU 155 is adapted to operate in parallel with the GPU 135. Each additional GPU 155 generates pixel data for output images from rendering commands. Each additional physical GPU 155 can be configured as multiple virtual GPUs that are used in parallel (concurrently) by a number of applications executing in parallel. Each additional GPU 155 can operate in conjunction with the GPU 135 to simultaneously generate pixel data for different portions of an output image, or to simultaneously generate pixel data for different output images.

Each additional GPU 155 can be located on the same circuit board as the GPU 135, sharing a connection with the GPU 135 to the data bus 160, or each additional GPU 155 can be located on another circuit board separately connected with the data bus 160. Each additional GPU 155 can also be integrated into the same module or chip package as the GPU 135. Each additional GPU 155 can have additional memory, similar to the display memory 140 and additional memory 145, or can share the memories 140 and 145 with the GPU 135.

FIG. 1B is a block diagram of an example of an end user or client device 200 capable of implementing embodiments according to the present invention. In the example of FIG. 1B, the client device 200 includes a CPU 205 for running software applications and optionally an operating system. The user input 220 includes devices that communicate user inputs from one or more users and may include keyboards, mice, joysticks, touch screens, and/or microphones. The communication interface 225 allows the client device 200 to communicate with other computer systems (e.g., the computer system 100 of FIG. 1A) via an electronic communications network, including wired and/or wireless communication and including the Internet. The decoder 255 is any device capable of decoding (decompressing) data that is encoded (compressed). For example, the decoder 255 may be an H.264 decoder. The display device 250 is any device capable of displaying visual information, including information received from the decoder 255. In particular, as will be described below, the display device 250 is used to display visual information received from the computer system 100. The components of the client device 200 are connected via one or more data buses 260.

Relative to the computer system 100, the client device 200 in the example of FIG. 1B has fewer components and less functionality and, as such, may be referred to as a thin client. However, the client device 200 may include other components including those described above. In general, the client device 200 may be any type of device that has display capability, the capability to decode (decompress) data, and the capability to receive inputs from a user and send such inputs to the computer system 100. However, the client device 200 may have additional capabilities beyond those just mentioned. The client device 200 may be, for example, a personal computer, a tablet computer, a television, or the like.

FIG. 2 illustrates a graphics system 130 in an embodiment according to the present invention. In the FIG. 2 embodiment, the graphics system 130 includes a physical GPU 135, although the graphics system 130 can include additional physical GPUs 155 as described above.

According to embodiments of the present invention, the physical GPU 135 is configured for concurrent use by a number N of applications 1, 2, . . . , N. More specifically, the physical GPU 135 is configured as a number M of virtual GPUs 235-1, 235-2, . . . , 235-M that are concurrently used by the applications 1, 2, . . . , N. Each of the additional GPUs 155 may be similarly configured as multiple virtual GPUs. In one embodiment, the GPU 135 and the additional GPUs 155 are coupled to a memory management unit 240 (MMU; e.g., an input/output MMU) that is in turn coupled to graphics memory, described in conjunction with FIG. 1A.

In one embodiment, the applications 1, 2, . . . , N are video game applications; however, the invention is not so limited. That is, the applications 1, 2, . . . , N can be any type of application. For example, the application may be a programming guide that provides, in table form, a list of the various programs that are available on different television channels in different time slots, and the client device may be a set top box (cable or satellite).

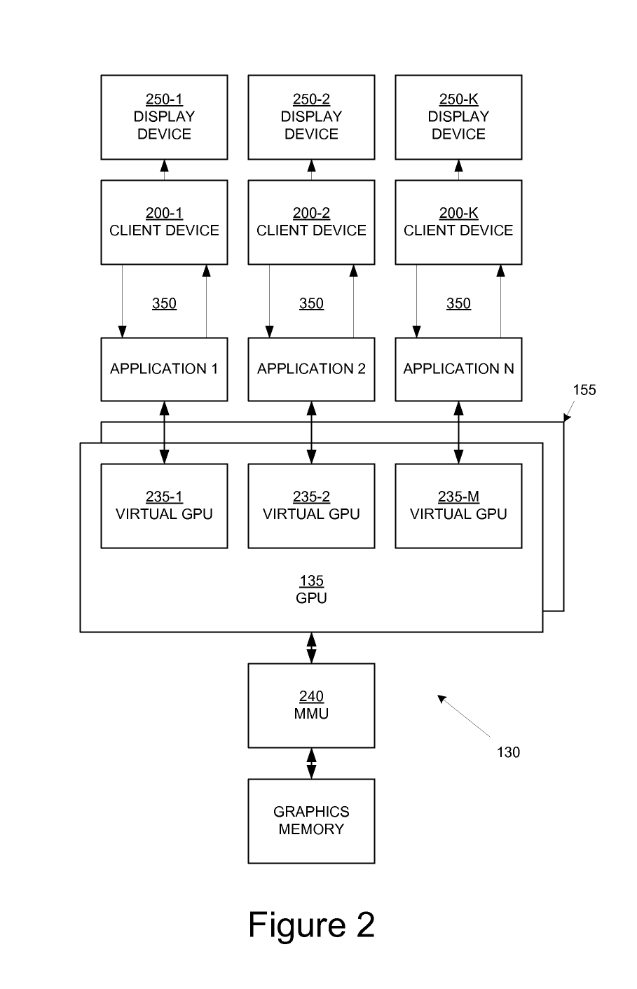

FIG. 3 is a block diagram of a system 300 including the computer system 100 in an embodiment according to the present invention. The computer system 100 is communicatively coupled to a number K of client devices 200-1, 200-2, . . . , 200-K over a network 350, such as the Internet. In the embodiment of FIG. 3, the computer system 100 is utilized as a centralized server device or data center; however, embodiments according to the present invention are not so limited.

The network 350 may be a wireless network, a wired network, or a combination thereof. The client devices 200-1, 200-2, . . . , 200-K are independent devices relative to the computer system 100. That is, the client devices 200-1, 200-2, . . . , 200-K are separate entities located remotely from the computer system 100 (e.g., they are separated from the computer system 100 by the network 350).

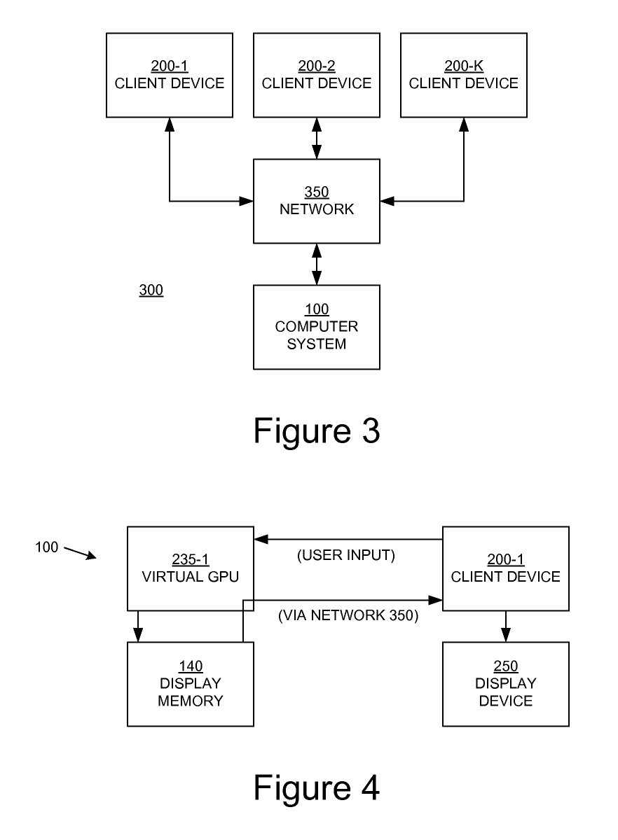

Significantly, with reference also to FIG. 2, the displays 250-1, 250-2, . . . , 250-K of the client devices 200-1, 200-2, . . . , 200-K are remote displays relative to the computer system 100. That is, the displays 250-1, 250-2, . . . , 250-K of the client devices 200-1, 200-2, . . . , 200-K are not directly connected to the computer system 100 via, for example, a low voltage display signal (LVDS) interface. Instead, the displays 250-1, 250-2, . . . , 250-K are accessible to the computer system 100 only via the respective client device 200-1, 200-2, . . . , 200-K (also see FIG. 4).

In operation, in one embodiment, the client devices 200-1, 200-2, . . . , 200-K provide control information (e.g., user inputs) to the computer system 100 over the network 350. Responsive to the control information, with reference also to FIG. 2, the computer system 100 executes the applications 1, 2, . . . , N to generate output data, which is transmitted to the client devices 200-1, 200-2, . . . , 200-K via the network 350. The output data may be encoded (compressed).

Significantly, the client devices 200-1, 200-2, . . . , 200-K are stateless in the sense that the applications 1, 2, . . . , N are not installed on them. Instead, the client devices 200-1, 200-2, . . . , 200-K rely on the computer system 100 to store and execute the applications 1, 2, . . . , N.

More specifically, in one embodiment, the client device 200-1 provides control information for application 1 to the computer system 100 over the network 350. In parallel, the client device 200-2 provides control information for application 2 to the computer system 100 over the network 350. The applications 1 and 2 may be the same application (e.g., they may be instances or copies of the same video game), or they may be different applications.

In response to the inputs from the client device 200-1, the virtual GPU 235-1 is utilized by the application 1 to generate display data (output data) related to the application 1. The display data related to application 1 is sent to the client device 200-1 over the network 350. In parallel, in response to the inputs from the client device 200-2, the virtual GPU 235-2 is utilized by the application 2 to generate display data (output data) related to the application 2. The display data related to application 2 is sent to the client device 200-2 over the network 350. The display data can be encoded using a common, widely used, and standardized scheme such as H.264.

In one embodiment, the computer system 100 accesses information to determine whether or not a client device is authorized to use one or more of the applications 1, 2, . . . , N. For example, a user may establish an account that includes a password and other identifying information, and access to the applications 1, 2, . . . , N is denied without such an account. Alternatively, a smart card or dongle may need to be plugged into the client device in order to gain access to any of the applications 1, 2, . . . , N.

FIG. 4 is a block diagram representing the flow of data from, for example, the virtual GPU 235-1 to the client device 200-1 in an embodiment according to the present invention. In the FIG. 4 example, the virtual GPU 235-1 generates a frame of image data that is stored in the display memory (framebuffer) 140. The frame of image data is encoded by the virtual GPU 235-1 and streamed from the framebuffer 140 to the client device 200-1 via the network 350. The client device 200-1 decodes the streamed data for display on the display device 250.

Thus, the virtual GPU 235-1 outputs encoded data (e.g., encoded image data) that is complete and ready to be decoded and displayed. As a result, the client device 235-1 can be thin and relatively inexpensive but still capable of satisfactory rendering the data.

In parallel with the above, other virtual GPUs 235-2, . . . , M of the GPU 135 can be utilized by other applications used by other client devices, and other GPUs (comprising still more virtual GPUs) can be utilized by yet more applications used by yet more client devices. In this manner, the server device (the computer system 100) and other similar networked server devices can support large numbers of client devices and users.

FIG. 5 is a flowchart 500 of an example of a computer-implemented method for providing virtualized graphics processing for remote display in an embodiment according to the present invention. The flowchart 500 can be implemented as computer-executable instructions residing on some form of computer-readable storage medium (e.g., using computer system 100 of FIG. 1A).

In block 502 of FIG. 5, user inputs are accessed or received from end user devices (e.g., the client devices 200-1, 200-2, . . . , 200-K). The inputs are received at a centralized server device (e.g., the computer system 100) having a GPU (e.g., the GPU 135) configured for concurrent use by multiple applications (the applications 1, 2, . . . , N) executing in parallel. That is, the GPU is implemented as multiple virtual GPUs (the virtual GPUs 235-1, 235-2, . . . , 235-M).

The user inputs are associated with applications executing in parallel on the computer system (e.g., the computer system 100). The user inputs include a first user input received from a first end user device and a second user input received from a second end user device. In particular, the user inputs include a first user input received from an independent first client device, where the first user input is associated with a first application.

In block 504, responsive to the user inputs, data is generated using the GPU. The data includes, for example, first data generated in response to the first user input, and second data generated in response to the second user input. In particular, the first data may include graphics data suitable for display, and the second data may include graphics data suitable for display.

In block 506, the data is directed to the end user devices (e.g., the client devices 200-1, 200-2, . . . , 200-K). In particular, the first data is sent to the first end user device, and the second data is sent to the second end user device. Each of the end user devices is operable for decoding the data for display on a respective display device.

In summary, in embodiments according to the present invention, hardware (e.g., the GPU 135) used to execute applications (e.g., the applications 1, 2, . . . , N) is instantiated on a server device (e.g., the computer system 100). In particular, the GPU is implemented as multiple virtual GPUs (the virtual GPUs 235-1, 235-2, . . . , 235-M); thus, the GPU can be utilized by multiple applications executing in parallel (during the same period of time). The virtual GPUs output encoded data (e.g., encoded image data) that only needs to be decoded for display. That is, in one embodiment, the output data is in a form that is complete in every sense except for the decoding. As a result, users can utilize the applications with only a thin and relatively inexpensive client device (e.g., the client devices 200-1, 200-2, . . . , 200-K). Consequently, significant hardware updates such as advanced GPUs can be implemented at the server, and thus users do not have to purchase new devices as technologies evolve. Also, the server can compress the output (e.g., display) data using a commonly used format such as the H.264 format that is implemented across the client devices. Therefore, it is not necessary to develop and maintain different versions of the applications to suit different types of client platforms. Furthermore, DRM is facilitated because the applications reside on the server, making it easier to control their distribution and use.

By controlling the applications and hardware on the server device, and by limiting access to authorized users, a secure environment is provided. A user simply connects to the server device over a network such as the Internet to start a session and executes an application of interest. The application may produce frames of image data that are generated by a GPU comprising multiple virtual GPUs, and that are compressed using a standardized and widely used compression scheme. The output data is sent to a client device, which may be a thin client device, for display. In a gaming environment, for example, the applications are video games that can be readily shared between users within the framework permitted by the prevailing DRM agreement. However, embodiments according to the present invention are not limited to video games and the like.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered as examples because many other architectures can be implemented to achieve the same functionality.

The process parameters and sequence of steps described and/or illustrated herein are given by way of example only. For example, while the steps illustrated and/or described herein may be shown or discussed in a particular order, these steps do not necessarily need to be performed in the order illustrated or discussed. The various example methods described and/or illustrated herein may also omit one or more of the steps described or illustrated herein or include additional steps in addition to those disclosed.

While various embodiments have been described and/or illustrated herein in the context of fully functional computing systems, one or more of these example embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system. These software modules may configure a computing system to perform one or more of the example embodiments disclosed herein. One or more of the software modules disclosed herein may be implemented in a cloud computing environment. Cloud computing environments may provide various services and applications via the Internet. These cloud-based services (e.g., software as a service, platform as a service, infrastructure as a service, etc.) may be accessible through a Web browser or other remote interface. Various functions described herein may be provided through a remote desktop environment or any other cloud-based computing environment.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as may be suited to the particular use contemplated.

Embodiments according to the invention are thus described. While the present disclosure has been described in particular embodiments, it should be appreciated that the invention should not be construed as limited by such embodiments, but rather construed according to the below claims.

What is claimed is:

1. A computer-readable storage medium having computer-executable instructions for causing a computer system to perform a method comprising:
receiving first user input at a centralized server device comprising a graphics processing unit (GPU) configured for concurrent use by a plurality of applications executing in parallel, wherein the first user input is received from an independent first client device communicatively coupled to the server device and wherein the first user input is associated with a first application of the plurality of applications;
generating first data with the GPU according to the first user input, the first data comprising graphics data suitable for display; and
sending the first data from the server device to the first client device, wherein the first client device is configured to decode the first data for display on a display device.

2. The computer-readable medium of claim 1 wherein the display device is inaccessible to the server device except via the first client device.

3. The computer-readable medium of claim 1 wherein the first data is sent from the server device to the first client device via a wireless connection.

4. The computer-readable medium of claim 1 wherein the method further comprises accessing information indicating that the first application is available to the first client device.

5. The computer-readable medium of claim 1 wherein the first data comprises compressed image data that is streamed from the server device to the first client device.

6. The computer-readable medium of claim 1 wherein the method further comprises performing operations in parallel with the receiving, generating, and sending, the operations in parallel comprising:
receiving second user input at the centralized server device, wherein the second user input is received from an independent second client device communicatively coupled to the server device and wherein the second user input is associated with a second application of the plurality of applications;
generating second data with the GPU according to the second user input, the second data comprising graphics data suitable for display; and
sending the second data from the server device to the second client device.

7. The computer-readable medium of claim 1 wherein the first application comprises a video game.

8. A computer system comprising:
a central processing unit (CPU);
a graphics processing system coupled to the CPU and comprising a graphics processing unit (GPU) operable as a plurality of virtual GPUs that are concurrently utilized by a plurality of applications executing in parallel;
a communication interface operable for sending and receiving data; and
memory coupled to the graphics processing system and having stored therein instructions that, if executed by the computer system, cause the computer system to execute operations comprising:
accessing first user input received from an independent first client device via the communication interface, wherein the first user input is associated with a first application of the plurality of applications;
generating first data with a first virtual GPU of the plurality of virtual GPUs according to the first user input, the first data comprising graphics data suitable for display; and
sending the first data to the first client device, wherein the first client device is operable for decoding the first data for display on a display device.

9. The computer system of claim 8 wherein the display device is inaccessible to the computer system except via the first client device.

10. The computer system of claim 8 wherein the first data is sent to the first client device via a wireless connection.

11. The computer system of claim 8 wherein the operations further comprise receiving information indicating that the first application is accessible by the first client device.

12. The computer system of claim 8 wherein the first data comprises compressed image data that is streamed from the server device to the first client device.

13. The computer system of claim 8 wherein the operations further comprise performing operations in parallel with the accessing, generating, and sending, the operations in parallel comprising:
accessing second user input received from an independent second client device via the interface device, wherein the second user input is associated with a second application of the plurality of applications;
generating second data with a second virtual GPU of the plurality of virtual GPs according to the second user input, the second data comprising graphics data suitable for display; and
sending the second data to the second client device.

14. The computer system of claim 8 wherein the first application comprises a video game.

15. A method comprising:
receiving a plurality of user inputs from a plurality of end user devices, the user inputs associated with a plurality of applications executing in parallel on a computer system, the user inputs comprising a first user input received from a first end user device and a second user input received from a second end user device;
responsive to the user inputs, generating data using a graphics processing unit (GPU) configured as a plurality of virtual GPUs that are concurrently utilized by the plurality of applications, the data comprising first data generated in response to the first user input, the data further comprising second data generated in response to the second user input; and
directing the data to the end user devices, wherein the first data is sent to the first end user device and the second data is sent to the second end user device.

16. The method of claim 15 wherein the end user devices are configured to decode the data for display on a respective display device.

17. The method of claim 15 wherein the data is sent to the end user devices via wireless connections.

18. The method of claim 15 further comprising accessing information indicating that the applications are available to the end user devices.

19. The method of claim 15 wherein the data comprises compressed image data that is streamed to the end user devices.

20. The method of claim 15 wherein the applications comprise video games.

21. A computer system comprising:
a bus;
a central processing unit (CPU) coupled to the bus;
a physical graphics processor unit (GPU) coupled to the bus, the physical GPU configured to implement a plurality of virtual GPUs;
a memory device coupled to the bus that stores a plurality of applications, wherein each virtual GPU of the plurality of virtual GPUs is operable to execute a respective application of the plurality of applications and wherein the plurality of applications is executed concurrently and wherein further each application is operable to generate respective display data based on execution thereof; and
a communication interface coupled to the bus and operable for communicating the display data of the plurality of applications for receipt by a plurality of remote client devices for display thereon.

22. The computer system of claim 21 wherein the plurality of applications are game applications and wherein the display data comprises graphics data corresponding to game play.

23. The computer system of claim 21 wherein the communication interface is also operable for receiving user input data from the plurality of remote client devices and wherein further the plurality of applications is responsive to the user input data in generating the display data.

24. The computer system of claim 21 wherein the display data is compressed data.

25. The computer system of claim 21 further comprising a plurality of physical GPUs configured to implement virtual GPUs.

26. The computer system of claim 21 wherein the communicating occurs via wired communication paths and wireless communication paths.

27. The computer system of claim 21 wherein the communicating occurs via a communication path comprising the Internet.
